(19) United States
(12) Patent Application Publication
(10) Pub. No.: US 2002/0121416 A1
(43) Pub. Date: Sep. 5, 2002

(54) Hydraulic cylinder apparatus

(76) Inventors: Yohei Katayama, Yokohama-shi (JP); Takashi Nezu, Yokohama-shi (JP); Kenichi Nakamura, Kawasaki-shi (JP)

Correspondence Address: BRINKS HOFER GILSON & LIONE, P.O. BOX 10395, CHICAGO, IL, 60610, US

(21) Appl. No.: 10/077,682

(22) Filed: Feb. 15, 2002

(30) Foreign Application Priority Data
Feb. 19, 2001 (JP) JP2001-042360

(51) Int. Cl. F16F 9/00

(52) U.S. Cl. 188/314; 188/298; 188/313; 188/318; 188/315

(57) ABSTRACT

A free piston defines a gas chamber in a cylinder, an interior of which is divided into a rod-side chamber and a bottom-side chamber by a piston. An accumulator having a gas chamber is connected to the rod-side chamber by a first oil line, midway of which is provided a damping-force generating unit. Also, the bottom-side chamber and the first oil line are communicated to each other by a communication line, midway of which is provided a spring-constant switchover valve for communication and shut-off of the communication line. Accordingly, when the spring-constant switchover valve puts the communication line in communication, the two gas chambers are compressed to make a spring constant small, thereby making comfort in a vehicle favorable. Meanwhile, the spring-constant switchover valve shuts off the communication line, only one of the gas chambers is compressed to make the spring constant large, thereby limiting a contracting displacement of a piston rod and suppressing rolling of the vehicle.

### BACKGROUND OF THE INVENTION

1. Field of the Invention

The invention relates to a hydraulic cylinder apparatus provided in, for example, on a vehicle or the like to be suitable for use in damping of vibrations.

2. Description of the Related Art

Generally, a suspension system for suspension of a vehicle body on wheels is provided on a vehicle or the like, and comprises hydraulic cylinder apparatuses for damping of vibrations and suspension springs for elastically supporting the vehicle body on wheels.

Incidentally, a hydraulic cylinder apparatus constituting such suspension system is substantially composed of a cylinder, one end of which is closed by a bottom cap and the other end of which is provided with a rod guide, a piston slidably inserted in the cylinder to define a rod-side oil chamber and a bottom-side oil chamber in the cylinder, and a piston rod, one end of which is fixed to the piston and the other end of which projects contractably from the cylinder through the rod guide. Also, the hydraulic cylinder apparatus is provided with a damping-force generating unit, which imparts a resistance to a flowing oil liquid when the piston rod contracts or extends from the cylinder, thereby generating a damping force.

Also, some hydraulic cylinder apparatuses comprise an accumulator for receiving an oil liquid discharged from a cylinder in accordance with a volume, by which a piston rod enters into the cylinder, when the piston rod enters into the cylinder. A hydraulic cylinder apparatus of this kind is well known from, for example, Japanese Patent Laid-Open No. 113140/1990 and the like. The hydraulic cylinder apparatus disclosed in Japanese Patent Laid-Open No. 113140/1990 is provided with a damping-force generating unit of damping force adjustment type, which is disposed midway an oil liquid line connecting between a cylinder (oil chamber) and an accumulator.

The hydraulic cylinder apparatus thus constructed mounts a bottom side of, for example, the cylinder to a wheel side of a vehicle, and a projecting end of the piston rod to a vehicle body of the vehicle. And at the time of normal traveling, comfort in the vehicle is made favorable by adjusting the damping force of the damping-force generating unit in a manner to make the same small. On the other hand, when the vehicle travels in a corner (cornering), the damping force of the damping-force generating unit is made large to suppress the vehicle from rolling.

Meanwhile, there are some hydraulic cylinder apparatuses, in which oil chambers arranged on right and left sides of vehicles are connected by a piping, the hydraulic cylinder apparatus of this kind being known from, for example, Japanese Utility Model Publication No. 29914/1972 and the like.

With the hydraulic cylinder apparatus disclosed in Japanese Utility Model Publication No. 29914/1972, a rod-side oil chamber of a left-side hydraulic cylinder apparatus and a bottom-side oil chamber of a right-side hydraulic cylinder apparatus are connected by a piping and a rod-side oil chamber of the right-side hydraulic cylinder apparatus and a bottom-side oil chamber of the left-side hydraulic cylinder apparatus are connected by a piping.

With such arrangement, when a vehicle effects cornering, a suspension disposed outside tends to contract and a suspension disposed inside tends to extend. However, when a piston rod of the outside hydraulic cylinder apparatus contracts, pressure in the lower oil chamber increases and acts on the upper oil chamber of the inside hydraulic cylinder apparatus through the piping. As a result, the piston rod of the inside hydraulic cylinder apparatus is restricted in extending movements, so that rolling during cornering is suppressed.

With the above-mentioned hydraulic cylinder apparatus disclosed in Japanese Patent Laid-Open No. 113140/1990, the damping-force generating unit is given an adjusting function for adjustment of a magnitude of a damping force in accordance with the traveling condition of a vehicle. Since the damping force only imparts a resistance to a flowing oil liquid, however, a period of time until the vehicle is inclined is merely prolonged at the time of cornering. Thus when traveling in a large corner, there is caused a problem that the vehicle is inclined to an inclination (steady roll) according to a radius of a corner and a traveling speed, and so rolling cannot be suppressed.

Also, with the hydraulic cylinder apparatus disclosed in Japanese Utility Model Publication No. 29914/1972, two hydraulic cylinder apparatus are connected through pipings, which takes times in arranging the pipings when the hydraulic cylinder apparatuses are to be mounted on a vehicle, thus causing a problem in lowering of workability. Further, these hydraulic cylinder apparatuses involve a problem that the response speed is delayed because resistance is generated when an oil liquid flows through the pipings.

### SUMMARY OF THE INVENTION

The invention is contemplated in view of the above-mentioned problems, and has its object to provide a hydraulic cylinder apparatus, in which spring forces are made variable and which are good in mounting property.

When the hydraulic cylinder apparatus of the invention is applied to an automobile, the vehicle traveling stability can be improved by increasing a spring force resisting that inclination, which the vehicle effects in right and left directions and front and rear directions.

In order to solve the above problems, the invention provides a hydraulic cylinder apparatus comprising a cylinder, a piston inserted slidably inserted into the cylinder to compartment an interior of the cylinder into a first chamber and a second chamber, a piston rod having one end thereof fixed to the piston and the other end thereof extending outside, a first spring element connected to the first chamber and composed of an accumulator, a second spring element connected to the second chamber and composed of an accumulator, a damping element provided at least one of between the first chamber and the first spring element and between the second chamber and the second spring element, a communication line connecting between a first hydraulic pressure circuit composed of the first chamber and the first spring element and a second hydraulic pressure circuit composed of the second chamber and the second spring element, and a switchover valve provided in the communication line for switching between a communication state, in which an oil liquid is permitted to flow in both directions between the first hydraulic pressure circuit and the second hydraulic pressure circuit and a shut-off state, in which at least flow toward one of the circuits from the other of the circuits is shut off.

With such arrangement, when the piston rod displaces in a state, in which the switchover valve puts the communication line in communication, the oil liquid in one of the chambers is supplied to both of the first spring element and the second spring element, whereby the spring force is decreased at this time. Thereby, the piston rod can easily displace.

On the other hand, when the piston rod displaces in a state, in which the switchover valve shuts off the communication line, only one of the first spring element and the second spring element is greatly compressed, and so the spring force is increased at this time.

Also, according to the invention, the communication line connects between the chamber in the cylinder and the damping element, whereby an amount of oil liquid flowing through the damping element at the time of shutting-off of the switchover valve can be made larger than an amount of oil liquid at the time of communication, so that the damping force when the switchover valve is shut off can be made larger than that at the time of communication.

### BRIEF DESCRIPTION OF THE DRAWINGS

FIG. 1 is a longitudinal cross-sectional view showing a hydraulic cylinder apparatus according to a first embodiment of the invention;

FIG. 2 is a longitudinal cross-sectional view showing the hydraulic cylinder apparatus in the first embodiment when a main line is shut off by a spring-constant switchover valve;

FIG. 3 is a longitudinal cross-sectional view showing a hydraulic cylinder apparatus according to a second embodiment of the invention;

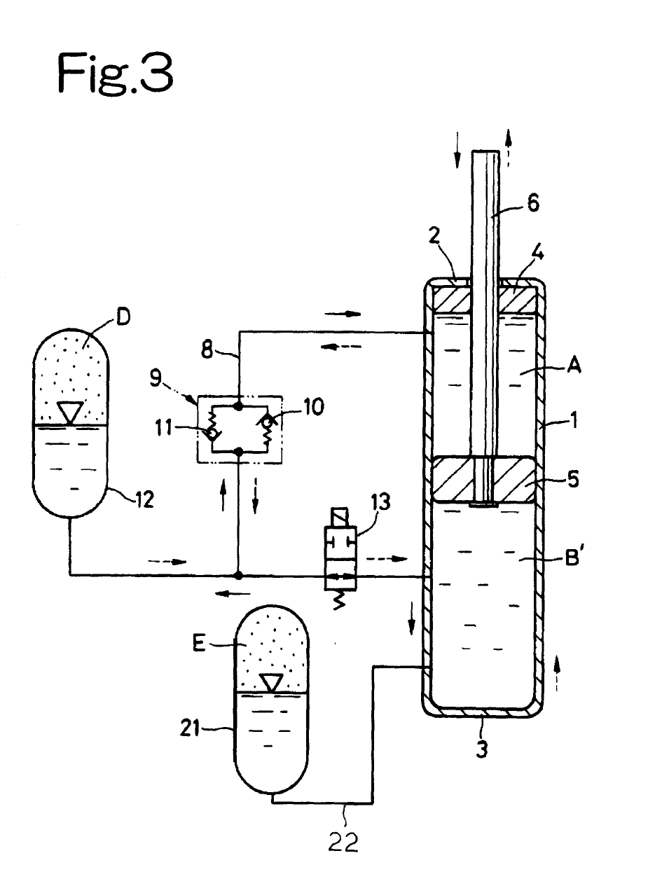

FIG. 4 shows eight circuit diagrams of hydraulic cylinder apparatus in modified examples of the invention; and

FIG. 5 is a longitudinal cross-sectional view showing a hydraulic cylinder apparatus according to a third embodiment of the invention.

### DESCRIPTION OF THE PREFERRED EMBODIMENTS

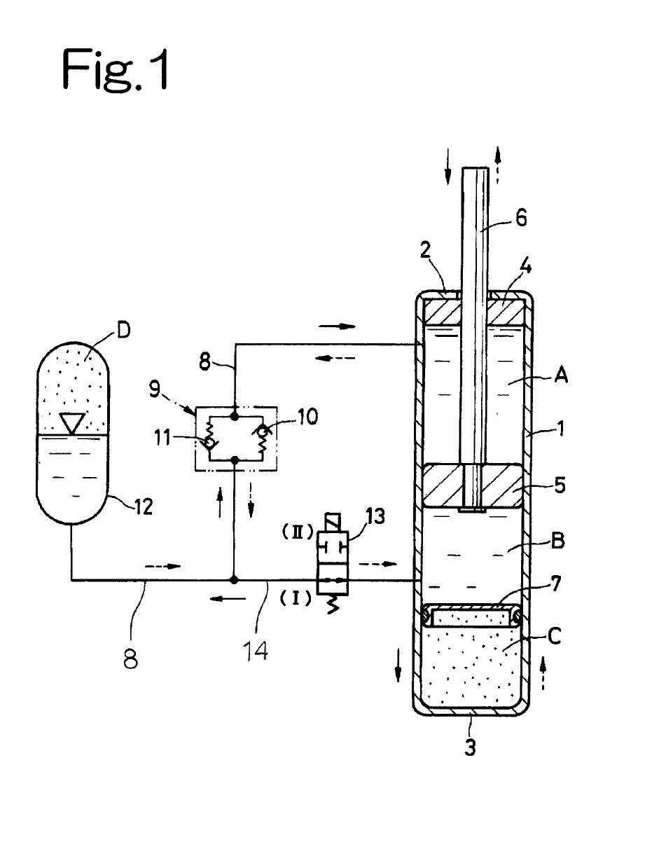

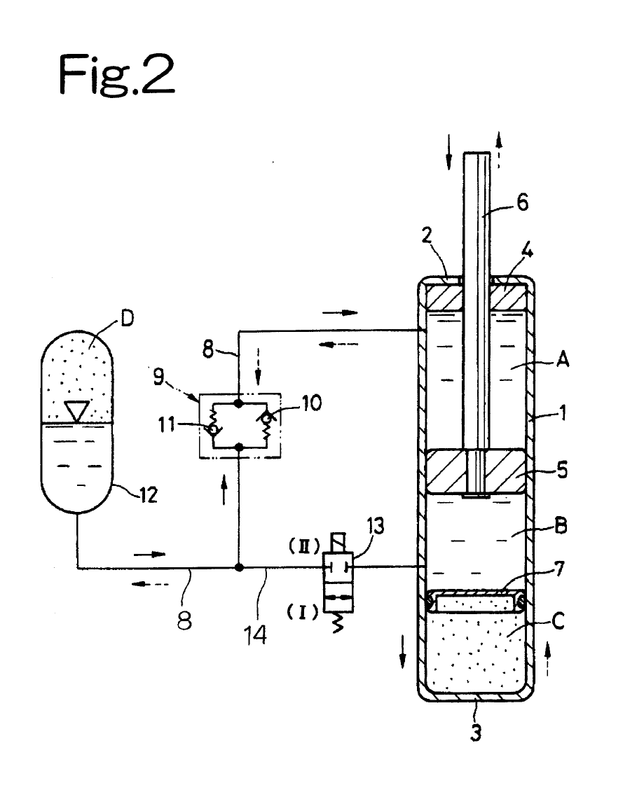

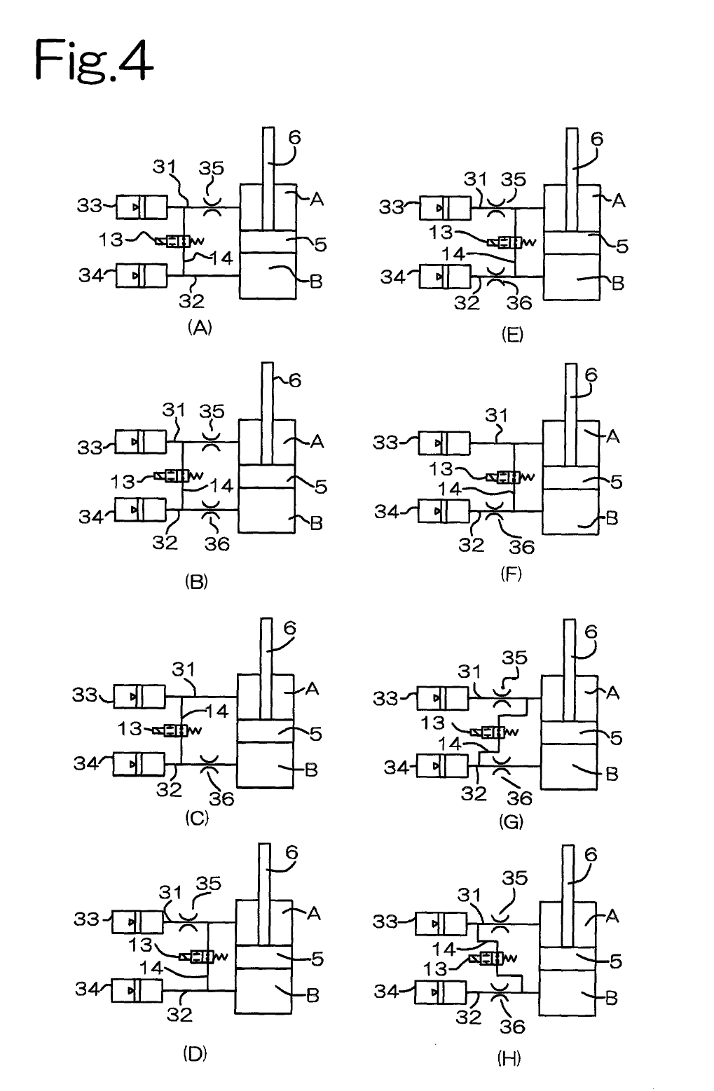

A hydraulic cylinder apparatus according to a first embodiment of the invention will be described below in detail by way of application to a vehicle, such as four-wheeled vehicles or the like, with reference to FIGS. 1 and 2. In addition, FIG. 4 shows various constitutional patterns of the hydraulic cylinder apparatus of the invention, the first embodiment corresponding to a pattern (A) shown in FIG. 4.

The reference numeral 1 denotes a cylindrical-shaped cylinder, which forms an outer shell of a hydraulic cylinder apparatus, the cylinder 1 being closed at an upper side by an upper cap 2 and at a lower side by a bottom cap 3. Also, provided inside the upper cap 2 is a rod guide 4 for axially slidably guiding a piston rod 6 described later. And a mount portion (not shown) conformed to a vehicle is fused to a side of the bottom cap 3 and mounted to a side of a wheel (not shown) of the vehicle.

The reference numeral 5 denotes a piston inserted slidably into the cylinder 1, which defines an upper rod-side oil chamber A corresponding to a first chamber of the invention and a lower bottom-side oil chamber B corresponding to a second chamber of the invention in the cylinder 1.

The reference numeral 6 denotes a piston rod inserted into the cylinder 1, the piston rod 6 being mounted at a lower end thereof to the piston 5. Also, an upper-side portion of the piston rod 6 projects movably outside the cylinder 1 through the rod guide 4, the projecting end being worked corresponding to the vehicle to be mounted a vehicle body (not shown) of the vehicle.

The reference numeral 7 denotes a free piston disposed below the piston 5 and inserted slidably into the cylinder 1, the free piston 7 defining between it and the bottom cap 3 a gas chamber C charged with a pressurized gas. Hereupon, the bottom-side oil chamber B, the free piston 7, and the gas chamber C constitute a gas spring as a second spring element, and further constitute a second hydraulic circuit.

And when the piston rod 6 contracts and the piston 5 displaces downward, the free piston 7 displaces downward to compress the gas chamber C. At this time, the gas chamber C is compressed to be increased in spring force and spring constant.

Meanwhile, when the piston rod 6 extends and the piston 5 displaces upward, the free piston 7 displaces upward to expand the gas chamber C. At this time, the gas chamber C is expanded to be decreased in spring force and spring constant. In this manner, as the gas chamber C is compressed through the free piston 7, it is increased in spring constant.

The reference numeral 8 denotes a first oil line connected at one end thereof to the rod-side oil chamber A and at the other end thereof to an accumulator 12, and a damping-force generating unit 9 as a damping element is provided midway the first oil line 8.

And the damping-force generating unit 9 is provided with a damping valve 10 on an extension side and a damping valve 11 on a contraction side. The accumulator 12, the first oil line 8, the damping-force generating unit 9, and the rod-side oil chamber A constitute a first hydraulic circuit of the invention.

Hereupon, when the piston rod 6 is extended, the damping valve 10 on the extension side gives a resistance to an oil liquid, which flows through the first oil line 8 toward the bottom-side oil chamber B from the rod-side oil chamber A, thereby generating a damping force. Also, when the piston rod 6 contracts, the damping valve 11 on the contraction side gives a resistance to an oil liquid, which flows toward the accumulator 12 and the rod-side oil chamber A from the bottom-side oil chamber B to pass through the first oil line 8, thereby generating a damping force.

The reference numeral 12 denotes the accumulator as a first spring element connected to the first oil line 8, and a gas chamber D charged with a pressurized gas is provided in the accumulator 12 to serve as a gas spring. And the accumulator 12 supplies and discharges the oil liquid between itself and the rod-side oil chamber A, and between itself and the bottom-side oil chamber B in accordance with extending and contracting displacements of the piston rod 6.

The reference numeral 13 denotes a spring-constant switchover valve as a switchover valve provided on a communication line 14 connecting between the bottom-side oil chamber B and the first oil line 8. The spring-constant switchover valve 13 acts to provide communication and shut-off between the bottom-side oil chamber B being a second hydraulic circuit and the rod-side oil chamber A being a first hydraulic circuit, and the accumulator 12.

Also, the spring-constant switchover valve 13 is formed as an electromagnetic-type opening and closing valve. And the spring-constant switchover valve 13 is normally disposed in a valve opened position (I) as shown in FIG. 1. Meanwhile, when receiving a signal from a control unit (not shown) having detected a lateral acceleration (lateral G) acting on the vehicle, an operating amount of a steering, a sinking amount of the vehicle and the like, the valve is switched over to a valve closed position (II) as shown in FIG.2.

The hydraulic cylinder apparatus according to the embodiment is constructed as described above, and will be explained below with respect to the operation thereof.

When the piston rod 6 contracts and the piston 5 displaces downward in a state, in which the spring-constant switchover valve 13 is located in the valve opened position (I) to be communicated to the communication line 14, the oil liquid in the bottom-side oil chamber B compresses the gas chamber C through the free piston 7 and flows into the accumulator 12 through the communication line 14 and the first oil line 8 to compress the gas chamber D as shown by solid arrows in FIG. 1. Further, a part of the oil liquid in the bottom-side oil chamber B flows into the expanding rod-side oil chamber A through the first oil line 8 and the damping-force generating unit 9.

Also, when the piston rod 6 is extended and the piston 5 displaces upward, the gas chamber C expands, the free piston 7 displaces upward, the oil liquid in the accumulator 12 flows into the bottom-side oil chamber B through the first oil line 8 and the communication line 14, and the oil liquid in the contracting rod-side oil chamber A flows into the bottom-side oil chamber B through the first oil line 8, the damping-force generating unit 9 and the communication line 14 as shown by dotted arrows in FIG. 1.

Meanwhile, when the piston rod 6 contracts and the piston 5 displaces downward in a state, in which the spring-constant switchover valve 13 is located in the valve closed position (II) to shut off the communication line 14, the oil liquid in the bottom-side oil chamber B greatly compresses only the gas chamber C through the free piston 7 as shown by solid arrows in FIG. 2. At this time, the oil liquid is supplied into the expanding rod-side oil chamber A from the accumulator 12 through the first oil line 8 and the damping-force generating unit 9.

Also, when the piston rod 6 is extended and the piston 5 displaces upward, the gas chamber C expands and the free piston 7 displaces upward as shown by dotted arrows in FIG. 2. At this time, the oil liquid in the contracting rod-side oil chamber A flows into the accumulator 12 through the first oil line 8 and the damping-force generating unit 9.

An explanation will be given to an operation when the hydraulic cylinder apparatus according to the embodiment is applied on an automobile.

First, when a vehicle travels straight, a signal from a control unit causes the spring-constant switchover valve 13 to put the communication line 14 in communication, and so the oil liquid in the rod-side oil chamber A and the bottom-side oil chamber B compresses or expands both the gas chamber C in the cylinder 1 and the gas chamber D of the accumulator 12 in accordance with contracting and extending displacements of the piston rod 6. An amount of oil liquid amounts to (cross-sectional area of the piston rod×displacement of the piston rod 6), and the gas chambers C, D are only compressed or expanded a little (for example, a half each), thus the spring force becoming small. Therefore, the piston rod 6 can easily (softly) extend or contract to make comfort in the vehicle favorable.

Also, at this time, the damping-force generating unit 9 dampens vibrations by imparting a resistance to the oil liquid flowing through the first oil line 8 and the communication line 14 between the rod-side oil chamber A and the bottom-side oil chamber B, and the accumulator 12.

On the other hand, in the case where the vehicle travels in a corner (cornering), a signal from the control unit causes the spring-constant switchover valve 13 of the hydraulic cylinder apparatus, disposed outside the corner, to shut off the communication line 14, the oil liquid in the bottom-side oil chamber B compresses or expands only the gas chamber C in the cylinder 1 in accordance with contracting and extending displacements of the piston rod 6. Further, an amount of oil liquid at this time amounts to (cross-sectional area of the piston×displacement of the piston rod 6), and so the gas chamber C is much compressed, thus the spring force becoming large. Accordingly, pressure (spring force) in the gas chamber C acts in a direction, in which the piston rod 6 is extended, to prevent the piston rod 6 from contractingly displacing (hard), so that the vehicle can be inhibited from rolling at the time of cornering. In particularly, with the embodiment, a larger force can be generated since the bottom-side oil chamber B and the rod-side oil chamber A are completely shut off from each other.

Also, at this time, the damping-force generating unit 9 dampens vibrations by imparting a resistance to the oil liquid flowing through the first oil line 8 between the rod-side oil chamber A and the accumulator 12.

In this manner, according to the embodiment, when a vehicle travels straight, the spring-constant switchover valve 13 is used to provide communication between the bottom-side oil chamber B and the accumulator 12 to compress the two gas chambers C and D, thereby decreasing a spring force and spring-constant of the respective gas chambers C and D, so that it is possible to easily extend and contract the piston rod 6 to make comfort in the vehicle favorable.

On the other hand, when a vehicle travels in a corner, the spring-constant switchover valve 13 of the hydraulic cylinder apparatus disposed outside the corner shuts off between the bottom-side oil chamber B, and the accumulator 12 and the rod-side oil chamber A to compress only the gas chamber C, thereby increasing the spring force and spring constant of the gas chamber C. Thereby, the spring force (gas pressure) in the gas chamber C can be used to prevent the piston rod 6 from contractingly displacing, so that even when traveling in a large corner, the vehicle can be inhibited from rolling and the vehicle traveling stability can be improved.

Also, since the hydraulic cylinder apparatus according to the embodiment eliminates the use of piping connecting between hydraulic cylinder apparatuses like the prior art disclosed in Japanese Utility Model Publication No. 29914/1972, it is possible to omit the work of piping when hydraulic cylinder apparatuses are to be mounted on a vehicle to enhance workability and besides it is possible to increase a response speed to improve performances because of no piping connecting between the hydraulic cylinder apparatuses.

In addition, while the first embodiment employs the spring-constant switchover valve 13 comprising a valve adapted to be put in communicated and shut-off states, it is not limited thereto. Thus the valve may act as a check valve, by which in a shut-off state, only flow to the rod-side oil chamber A being a first hydraulic circuit and the accumulator 12 from the bottom-side oil chamber B is shut off and allows a reverse flow. Thereby, the spring force at the contraction can be varied. Also, when the check valve is oppositely directed, only the spring force at the time of extension can be varied.

Also, with the first embodiment, the first oil line 8 and the communication line 14 are schematically shown as being connected to the rod-side oil chamber A and the bottom-side oil chamber B from an outer periphery of the cylinder 1, but the piston rod 6 may be made hollow to provide a line which extends axially from a tip end thereof to be opened to only either the rod-side oil chamber A or the bottom-side oil chamber B, thereby constituting a first oil line and a communication line.

Also, while it is described in the first embodiment that the free piston 7 is provided in the cylinder 1 to define the gas chamber C, thereby constituting a second spring element, the invention is not limited thereto. For example, an accumulator 21 provided with a gas chamber E, which constitutes a second spring element, may be connected to a bottom-side oil chamber B′ through a second oil line 22.

Further, another embodiment of the invention is conceivable to have a constitution of patterns (A) to (H) shown in FIG. 4. In FIG. 4, the same reference numerals denote the same elements as those in the first embodiment, and so an explanation of the constitution and function thereof is omitted.

The pattern (A) is a schematic view showing configurations of the first and second embodiments, the reference numeral 33 denoting a first accumulator as a first spring element, and 34 a second accumulator as a second spring element. The first accumulator 33 and the second accumulator 34 are connected to the first chamber A and the second chamber B through a first oil line 31 and a second oil line 32.

The first oil line 31 is provided with a first damping element 35. The first damping element 35 is composed of an orifice and a damping valve, which generate damping forces in extending and contracting strokes, respectively.

The first oil line 31 and the second oil line 32 are connected to each other by a communication line 14, midway of which is provided a switchover valve 13 for putting the communication line 14 in communicated and shut-off states.

The pattern (A) functions in the same manner as in the first embodiment.

The pattern (B) is constituted by addition of a second damping element 36 to the second oil line 32 in the pattern (A), and is identical thereto in other points. Thereby, in the pattern (A) a part of the oil liquid flowing out of the bottom-side oil chamber B at the time of contraction of the piston rod 6 flows only into the damping element 35 and a damping force on a contracting side is hard to be set to be large, but in the pattern (B) the whole oil liquid flowing out of the bottom-side oil chamber B at the time of contraction of the piston rod 6 generates a damping force due to the resistance of the second damping element 36, so that it is possible to set a large damping force.

The pattern (C) is constituted by removing the first damping element 35 from the first oil line 31 in the pattern (B). With such arrangement, a damping force on the contracting side can be set to be large in contrast to the pattern (A) but a damping force on the extending side is hard to be set to be large.

The pattern (D) is constituted by changing a position where the communication line 14 is connected to the first oil line 31 in the above pattern (A), to a side of the first damping element 35 toward the cylinder. In this case, owing to communication and shutting-off of the spring-constant switchover valve 13, an amount of the oil liquid flowing through the first damping element 35 is made small at the time of communication and large at the time of shutting-off, with the result that a damping force at the time of communication is smaller than that at the time of shutting-off. Therefore, in the pattern (D) communication and shutting-off of the spring-constant switchover valve 13 can increase the damping force as well as the spring force.

As a result, it is general that as a spring force increases, damping of vibrations is made unfavorable, but in the pattern (D) damping of vibrations is made favorable since the damping force also increases.

In the pattern (E), positions where the communication line 14 is connected to the first oil line 31 and the second oil line 32 in the pattern (B) are changed to sides of the first damping element 35 and the second damping element 36 toward the cylinder. In this case, a damping force together with a spring force becomes variable as in the same manner as in the pattern (D).

In the pattern (F), the first damping element 35 in the pattern (E) is removed from the first oil line 31. In this case, a damping force together with a spring force becomes variable as in the same manner as in the pattern (D).

In the pattern (G), a position where the communication line 14 is connected to the first oil line 31 is changed to a side of the first damping element 35 toward the cylinder from that in the pattern (B). In this case, a damping force together with a spring force becomes variable as in the same manner as in the pattern (D).

In the pattern (H), a position where the communication line 14 is connected to the second oil line 32 is changed to a side of the second damping element 36 toward the cylinder from that in the pattern (B). In this case, a damping force together with a spring force becomes variable as in the same manner as in the pattern (D).

In addition, while the spring-constant switchover valve 13 is a communicating and shutting-off valve in the respective patterns, it may be one allowing a flow only in one direction in place of shutting-off both direction.

Also, while the piston 5 is not provided with any flow line in the respective patterns, it is not limited thereto.

The piston may be provided with a relief valve, which permits flow of the oil liquid between the oil chambers A and B only when high pressures prevail in one of the oil chambers A and B.

Further, in the case where it is desired that only a spring force on the contracting side be variable, the piston may be provided with a damping valve which permits flow toward the bottom-side oil chamber B from the rod-side oil chamber A, and in the case where it is desired that only a spring force on the extending side be variable, the piston may be provided with a damping valve which permits flow toward the rod-side oil chamber A from the bottom-side oil chamber B.

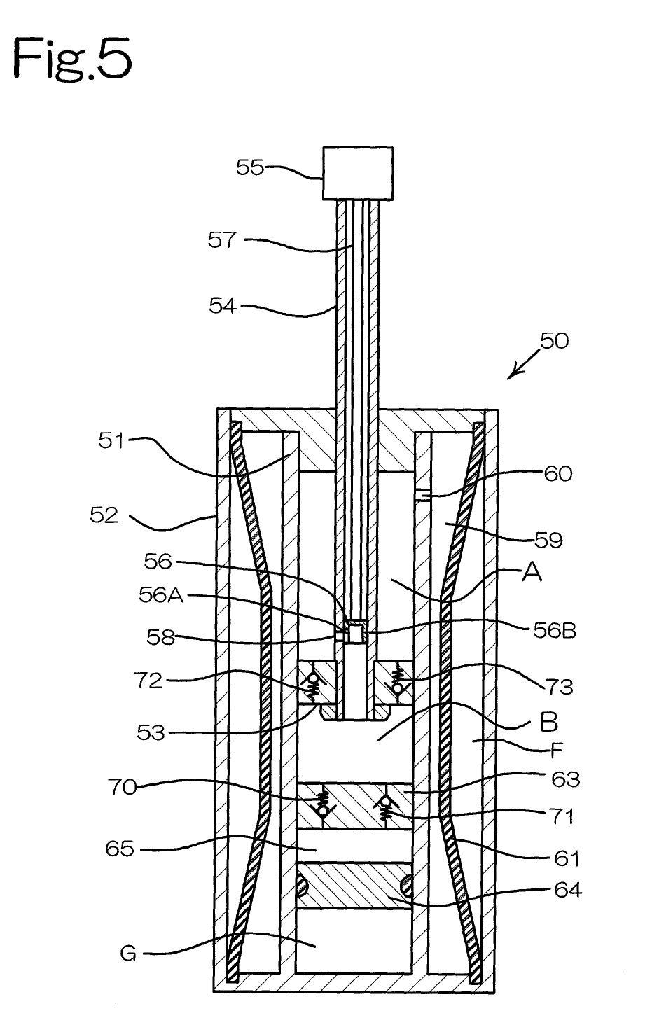

A third embodiment will be below explained and shown in FIG. 5.

The third embodiment is obtained by embodying the pattern (F) shown in FIG. 4. In FIG. 5, the same reference numerals denote the same elements as those in FIG. 1 and in the pattern (F) in FIG. 4, and so an explanation therefor is omitted.

A hydraulic cylinder apparatus 50 comprises a cylinder body composed of an inner cylinder 51 and an outer cylinder 52, an interior of the inner cylinder 51 being divided by a piston 53 into a rod-side oil chamber A being a first chamber and a bottom-side oil chamber B being a second chamber. Mounted to the piston 53 is a hollow piston rod 54, to a projecting end of which is mounted a rotary-type actuator 55 composed of a stepping motor. The actuator 55 is connected to a control unit (not shown) and controllably energized in accordance with a change in posture of a vehicle.

Connected to the actuator 55 is an operating rod 57, to which a shutter 56 is mounted. The shutter 56 is provided with a notch 56A and a wall portion 56B, and the rotating operation of the actuator 55 causes opening and closing of a communication hole 58 provided in the piston rod 54 to provide communication and shut-off between the rod-side oil chamber A and the bottom-side oil chamber B. The shutter 56 constitutes a switchover valve of the invention and the communication hole 58 constitutes a communication line.

The cylinder 51 is provided at an upper portion thereof with a cylinder communication hole 60 which communicates the rod-side oil chamber A to a first reservoir 59 provided between the cylinder 51 and the outer cylinder 52. The first reservoir 59 defines an outer pressurized gas chamber F with a rubber partition 61, and the pressurized gas chamber F, the partition 61, and the first reservoir 59 constituting a first spring element of the invention. Also, a first oil circuit of the invention is constituted by the first spring element, the rod-side oil chamber A, and the cylinder communication hole 60.

In addition, in the case where the cylinder communication hole 60 is made small in opening area, the cylinder communication hole 60 acts as a damping element, and thus the third embodiment is the same in constitution as that in the pattern (E) shown in FIG. 4.

A bottom valve member 63 is provided at a lower end of the bottom-side oil chamber B to be fixed to the cylinder 51, and a free piston 64 is slidably provided below the bottom valve member 63 to define an oil chamber 65 and a gas chamber G charged with a compressed gas. A second spring element in the invention is constituted by the free piston 64, the oil chamber 65 and the gas chamber G. Also, a second hydraulic circuit in the invention is constituted by the second spring element, the bottom valve member 63, and the bottom-side oil chamber B.

Provided in the bottom valve member 63 are a damping valve 70 on an extension side and a damping valve 71 on a contraction side, which generate resistance against flow of the oil liquid between the bottom-side oil chamber B and the oil chamber 65 to thereby generate damping forces, these valves constituting a damping element in the invention.

The damping valves 70, 71 are constituted by disk valves used in conventional hydraulic cylinder apparatus.

Provided in the piston 53 are a damping valve 72 on the extension side and a damping valve 73 on the contraction side, which generate resistance against flow of the oil liquid between the rod-side oil chamber A and the bottom-side oil chamber B to thereby generate damping forces, the damping valve 72 on the extension side being a usual damping valve permitting flow of the oil liquid since a low piston speed, the damping valve 73 on the contracting side being one which does not open below 0.6 m/s, that is, a piston speed at the time of normal traveling but opens at high speeds above the speed and which acts as a relief valve when pressure in the bottom-side oil chamber B becomes excessively high.

An explanation will be given to the operation of the hydraulic cylinder apparatus constructed according to the third embodiment.

First, when a vehicle travels straight, the actuator 55 causes the notch 56A in the shutter 56 to open the communication hole 58, and the oil liquid in the rod-side oil chamber A and the bottom-side oil chamber B compresses or expands the gas chamber F and the gas chamber G in accordance with extending and contracting displacements of the piston rod 54. An amount of oil liquid at this time amounts to (cross-sectional area of the piston rod 54×displacement of the piston rod 54), and the gas chambers F, G are only compressed or expanded a little (for example, a half each), thus the spring force at this time becoming small. Therefore, the piston rod 54 can easily (softly) extend or contract to make comfort in the vehicle favorable.

Also, at this time, the oil liquid, for example, an oil liquid of a half of (cross-sectional area of the piston rod 54×displacement of the piston rod 54), which will compress and expand the gas chamber G, flows through the extension-side damping valve 70 and the contraction-side damping valve 71 in the bottom valve member 63 to be given a resistance, thereby damping vibrations.

On the other hand, in the case where the vehicle travels in a corner (cornering), the actuator 55 is operatively energized to drive the shutter 56 of the hydraulic cylinder apparatus 50 disposed outside the corner to causes the wall portion 56B of the shutter 56 to shut off the communication hole 58, whereby the oil liquid in the bottom-side oil chamber B compresses only the gas chamber G in accordance with the contracting displacement of the piston rod 54. Further, an amount of oil liquid at this time becomes as large as (cross-sectional area of the piston rod 54×displacement of the piston rod 54), so that the gas chamber G is greatly compressed and the spring force produced thereby becomes large. Also, all of such large amount of the oil liquid flows through the contraction-side damping valve 71 to generate a large damping force. Accordingly, pressure (spring force) in the gas chamber G acts in a direction, in which the piston rod 54 is extended, to thereby inhibit the piston rod 54 from contractingly displacing (hard), so that the vehicle can be inhibited from rolling at the time of cornering and besides vibrations can be effectively suppressed because of a large damping force.

In the case where the wheel of the vehicle is considerably raised upward by projections on a road surface at the time of cornering, the contraction-side damping valve 73 in the piston 53 opens to prevent the bottom-side oil chamber B and the gas chamber G from being rapidly increased in pressure.

Also, when the piston rod 54 is extended, the extension-side damping valve 72 in the piston 53 opens, and so the spring force is made relatively small.

In addition, when the extension-side damping valve 72 in the piston 53 is removed, a large spring force is also obtainable in extension and contraction.

In addition, while the free piston is used in the respective embodiments to define the gas chamber and the oil chambers in the accumulator, a metallic bellows, rubber or the like may be used instead. Further, while a pressurized gas is used as a spring element in the respective embodiments, the invention is not limited thereto such that the gas chambers C, D, G and the like are opened to the atmosphere and coil springs are arranged in the gas chambers to bias the free piston.

In addition, while the respective embodiments have been explained, in which the switchover valve is automatically switched over when a lateral acceleration (lateral G) acting on a vehicle, an operating amount of steering, a sinking amount of the vehicle and the like become larger than set values, the invention is not limited thereto such that the switchover valve is manually switched over by a driver. Further, the switchover valve may be switched over by mechanically transmitting to a spring switchover valve a torsional force generated on a stabilizer provided between right and left unsprung masses at the time of cornering.

Further, while the respective embodiments have been explained by referring to the case of suppressing rolling generated when a vehicle effects cornering, they may be instead applied to the case of preventing a rear side of a vehicle from sinking at the time of acceleration (anti-squat) and the case of preventing a front side of a vehicle from sinking at the time of deceleration (anti-dive).

Also, while the embodiments have been explained by referring to the case where hydraulic cylinder apparatuses are applied to four-wheeled vehicles, the invention is not limited thereto but may be constituted to be applicable to, for example, hydraulic cylinder apparatuses mounted on other vehicles such as two-wheeled vehicles.

As described above in detail, the hydraulic cylinder apparatus according to the invention comprises a cylinder, a piston inserted slidably inserted into the cylinder to compartment an interior of the cylinder into a first chamber and a second chamber, a piston rod having one end thereof fixed to the piston and the other end thereof extending outside, a first spring element connected to the first chamber and composed of an accumulator, a second spring element connected to the second chamber and composed of an accumulator, a damping element provided at least one of between the first chamber and the first spring element and between the second chamber and the second spring element, a communication line connecting between a first hydraulic pressure circuit composed of the first chamber and the first spring element and a second hydraulic pressure circuit composed of the second chamber and the second spring element, and a switchover valve provided in the communication line for switching between a communication state, in which an oil liquid is permitted to flow in both directions between the first hydraulic pressure circuit and the second hydraulic pressure circuit and a shut-off state, in which at least flow toward one of the circuits from the other of the circuits is shut off. Thus the spring force can be changed with a simple constitution and the operation of the switchover valve.

Accordingly, when the hydraulic cylinder apparatus according to the invention is applied to an automobile, the operation of the switchover valve makes it possible to switch over to a state of favorable comfort in the automobile and a state of high stability in operation which suppresses a change in posture.

Also, with the patterns (D) to (H) shown in FIG. 4 and the third embodiment, the communication lines connect between the chambers in the cylinder and the damping elements whereby an amount of the oil liquid flowing through the damping elements when the switchover valve is shut off can be made larger than that at the time of communication and so the damping force when the switchover valve is shut off can be made larger than when the switchover valve is put into communication.

Thereby, the damping force can be made large together with the spring force, so that vibrations can be favorably damped even when the spring force is large.

1. An hydraulic cylinder apparatus comprising a cylinder,
a piston inserted such that it can be slidably inserted into the cylinder to compartment an interior of the cylinder into a first chamber and a second chamber,
a piston rod having one end thereof fixed to the piston and the other end thereof extending outside,
a first spring element connected to the first chamber and composed of an accumulator,
a second spring element connected to the second chamber and composed of an accumulator,
a damping element provided at least one of between the first chamber and the first spring element and between the second chamber and the second spring element,
a communication line connecting between a first hydraulic pressure circuit composed of the first chamber and the first spring element and a second hydraulic pressure circuit composed of the second chamber and the second spring element, and
a switchover valve provided in the communication line for switching between a communication state, in which an oil liquid is permitted to flow in both directions between the first hydraulic pressure circuit and the second hydraulic pressure circuit and a shut-off state, in which at least flow toward one of the circuits from the other of the circuits is shut off.

2. The hydraulic cylinder apparatus according to claim 1, wherein the communication line connects between at least one of the chambers in the cylinder and the damping element.

3. The hydraulic cylinder apparatus according to claim 1, wherein the communication line connects between the damping element and at least one of the spring elements.

4. The hydraulic cylinder apparatus according to claim 1, wherein the first spring element comprises a free piston, which compartments the interior of the cylinder into a pressurized gas chamber and an oil chamber.

5. The hydraulic cylinder apparatus according to claim 1, wherein damping elements are provided both between the first chamber and the first spring element and between the second chamber and the second spring element.
